(19) United States
(12) Patent Application Publication
(10) Pub. No.: US 2003/0021901 A1
(43) Pub. Date: Jan. 30, 2003

(54) Method for coating parts made of material based on sic, coating compositions, and resulting coated parts

(76) Inventor: Adrien Gasse, Grenoble (FR)

Correspondence Address: BURNS DOANE SWECKER & MATHIS L L P, POST OFFICE BOX 1404, ALEXANDRIA, VA, 22313-1404, US

(21) Appl. No.: 10/220,187

(22) PCT Filed: Mar. 13, 2001
(86) PCT No.: PCT/FR01/00739

(51) Int. Cl. B05D 3/02

(52) U.S. Cl. 427/376.2

(57) ABSTRACT

A method for covering a part made of silicon carbide material, wherein a coating compound is applied to at least one surface of said part and the assembly formed by the part and the coating compound is heated to a temperature sufficient to cause the surface of the coating compound to melt in order to coat said piece with a deposit of silicon carbide material and, wherein the coating compound is a non-reactive composition comprised of, in atomic percentages, from 40 to 97% silicon and 60 to 3% of another element selected from among chrome, rhenium, titanium, vanadium, ruthenium, iridium, rhodium, palladium, cobalt, platinum, cerium and zirconium and, wherein prior to heating, a SiC and/or C reinforcement is added.

Coating compounds and coated parts obtained by this method.

### DESCRIPTION

This invention relates to a method for coating silicon carbide based materials using a non-reactive silicon-based coating compound and another material. Furthermore, the invention relates to certain coating compounds, as well as to the coated pieces obtained using this method.

As used herein, materials “having a silicon carbide base” means generally all materials whose SiC content is greater than or equal to 80% by weight.

In general, the technical field of the invention can be defined as that of ceramic surface coatings. As used herein, “coating” is to be understood generally as the act of providing the surface of a ceramic piece with a deposited or a covering layer.

The purpose of a coating, for example, is to protect the ceramic against a corrosive environment, whether gaseous or liquid, such as a strongly oxidant, sulfurated, fluorinated, an acid or alkali environment, etc. Thus, not only must the covering be generally resistant to a corrosive environment but above all, it must effectively protect the ceramic. In the case of porous ceramics or composites that are normally porous, said covering must assure a sealant function relative to different liquid or gas environments. The covering modifying the surface of the ceramic must likewise provide an improvement of the ceramic's resistance to wear, friction, erosion, etc.

In particular, the field of the invention is that of covering the surface of a silicon carbide based ceramic in order to protect it, to seal it or to improve its mechanical properties using a substantially metallic layer, deposit or coating.

In fact, the field of application of the silicon carbide based ceramic products is very diverse. Due to manufacturing method factors but also in order to lighten the ceramic, one has resorted to products that are not dense and which may have significant porosity which could approach 50%, for example. These materials present a significant problem with respect to impermeability. Moreover, despite the remarkable properties of SiC: hardness, low coefficient of expansion, increased resistance to breakage, good resistance to thermal shock, chemical resistance to corrosion and oxidation, it is necessary to provide it with covering deposits in order to protect the sintered SiC or the SiC-based composites from oxidation or any corrosive environment. In particular, the sensitivity of the C/SiC composites to oxidation is very high.

Covering of components, both ceramic and materials of other types, is described in numerous documents.

So, for example, JP-A-11 087 discloses a combustion chamber made of a carbon-based composite material comprised of a carbon matrix reinforced with carbon or graphite filaments, wherein a SiC covering layer is formed on the inner surface of the composite and a carbon film, deposited by chemical means, is formed on the outer surface of the composite. The cracks in the SiC covering layer are then impregnated with tetraethyl orthosilicate and it is then thermally treated at a temperature of 1,400 to 2,000° C.

This technique is applied to carbon-carbon composite materials and not to SiC-based ceramics; furthermore, the covering method requires a large number of steps such as CVD deposit, impregnation, thermal treatment, etc. and is long and complicated. Ultimately, the deposited material is SiC and thus departs from the field of the invention, wherein the part to be covered is itself made of silicon carbide.

JP-B2-95 119079 discloses a part for a booster engine nozzle which comprises a carbon-carbon filament based composite, an intermediate layer comprised of CVD deposited long and short SiC or Si₃N₄ filaments and a final layer of ceramic and/or refractory metal and/or short impregnated filaments of SiC or Si₃N₄ deposited by CVD.

Again, this method is long and complicated and it applies to carbon-carbon composites and not to SiC-based ceramics.

JP-A-53 25857 relates to protection of a resistive film whose properties are not specified. The protective layer is comprised of at least one metal and one comprised of silicon carbide and/or silicon nitride. The metal is selected from Hf, Nb, Ta, Mo, W, Re, Ru, Rh and Ir. This system is reactive and, until proved otherwise, this document is not relevant to coating of ceramics.

U.S. Pat. No. 5,294,489 discloses a protective coating for the reinforcement phase, for example, of C or SiC of a composite material having a silicon carbide matrix formed by infiltration of molten silicon. This protective coating is comprised of an inner layer of a material resistant to reaction with molten silicon, an intermediate layer of a material reacting with the infiltrant compound in the matrix as well as with the molten silicon to form a compound with a higher melting temperature than that of the infiltrant compound and the silicon, and an outer layer of a material resistant to reaction with the molten silicon.

The materials forming the outer layers and/or the inner layers can be carbides, nitrides, borides, oxides, silicides of metals.

This document relates to the inner protection of a reinforcement of a composite and not to the outer protection provided by the surface of a ceramic body or part as such. Furthermore, the formation of the deposit is very difficult to control because it involves the utilization of three layers, one of which is obtained by a delicate reaction between the liquid Si and the metal.

In a general fashion, coating of ceramics by melting and cooling of a metal alloy should overcome the fundamental problem of poor “wettability” of ceramics by liquid metals.

An essentially reactive coating such as that described in the documents cited above could be adapted to coating of oxide ceramics such as aluminum, because the reactivity is limited and the mechanical behavior of the oxides formed is satisfactory.

In the case of the non-oxide ceramics such as nitrides or carbides of silicon, which are of particular interest to us here, the reactivity between the active components of the metallic alloy and the ceramic is particularly exacerbated; said latter induces the formation of fragile intermetallic compounds such as silicides and carbides in the case of SiC, significant porosity, and cracks extending through the ceramic, which very seriously limits the mechanical resistance of the coatings formed in this fashion.

Another significant problem encountered at the time of coating of the ceramics is that said ceramics are brittle and practically devoid of any capacity to deformability, even at high temperatures.

It is thus fundamental, when realizing the deposition onto the ceramic, to limit residual stresses that develop at the time of cooling and due to a difference in the coefficient of expansion between the deposit and between the ceramic and the deposit. Said residual stresses result in a poorly covering, heterogeneous deposit lacking coherence with the ceramic.

There is currently a need for a method that allows the coating of SiC ceramics using a very adherent, very uniform, very coherent but also very refractory deposit; that is, one capable of resisting temperatures that may reach up to 1,600° C. or even higher.

None of the coating methods and coating compounds disclosed in the prior art documents meet this requirement.

In particular, none of the prior art methods and compositions simultaneously fulfills the following criteria, demonstrated by the inventors and which are fundamental for realization of coatings for ceramics such as SiC, the deposits and the coated parts, being preferably very refractory:

1. The coating compound must allow a strong bond between the deposit and the ceramic part such as SiC.

2. The coating compound must wet the silicon carbide satisfactorily and adhere well to it.

3. The coating compound must have an expansion coefficient that is adapted to the SiC; that is, close to the coefficient of expansion of the SiC, in order to overcome any residual stress that may occur in the coating or the deposit when cooling and assure that there is no initiation of crack, which would compromise the mechanical performance of the deposit and the coated or covered piece.

4. The coating compound must be comprised of a limited number of components in order to facilitate its preparation and its utilization.

5. The deposit must be very refractory, allowing its realization at usage temperatures of 1,600° C. and higher.

6. Moreover, the deposit or the coating must be covering, homogeneous and coherent with the ceramic in order to protect the ceramic against corrosive environments of all types while otherwise assuring its impermeability relative to all liquid or, gaseous environments, even at high temperatures, with which the ceramic is in contact and enhancing its properties such as resistance to wear, erosion, friction, etc.

Furthermore, the method must allow coating of any type of ceramic, in particular those with high porosity, and must be capable of easily adapting to any specific SiC ceramic.

The method must be simple, reliable, reproducible, fast, easy to implement and consist of a limited number of steps.

The object of the invention is, therefore, to provide a method for coating parts or components made of silicon carbide based materials that responds to the foregoing needs, that satisfies at least the requirements and criteria described in the foregoing, that eliminates the drawbacks, defects, limitations found in the prior art methods, and which allows realization of at least very refractory, very adherent, very homogeneous, very covering deposits or coatings with increased bonding performance with the ceramic and devoid of cracking both at the time of creating the coating and under functional conditions.

Said object, and others still, are achieved according to the invention by a method of coating a silicon carbide part, wherein a coating compound is applied to at least one surface of said part and heating the assembly formed by the part and the coating compound to a temperature (the so-called “coating temperature”) sufficiently to cause the coating compound to melt so that said surface of the SiC part is coated with a deposit, wherein the coating compound is a non-reactive composition comprised of and expressed in atomic percentages: 40 to 97% silicon and 60 to 3% of another element selected from chrome, rhenium, titanium, vanadium, ruthenium, iridium, rhodium, palladium, cobalt, platinum, cerium and zirconium and wherein a reinforcing addition of SiC and/or is made prior to heating.

The method according to the invention responds to the need, satisfies the set of requirements and criteria mentioned above and is not burdened with the drawbacks of the prior art methods, thus allowing the production of very adherent and very refractory coatings.

The inventors have shown, in unexpected fashion, that in order for the above criteria to be fulfilled and, particularly for the coating compound, while being very refractory, to allow realization of a strong bond between the deposit (coating, covering) and the part, it was necessary that said coating not be reactive with SiC; that is, it must be chemically compatible with SiC.

Further, it has again been unexpectedly shown that in order for the coating compound to be non-reactive with SiC, the coating must be in the specific area of the atomic percents mentioned above.

The specific, very refractory suicides used in the method according to the invention generally have a coefficient of expansion higher than that of SiC and their range of non-reactive composition is not absolutely a priori foreseeable.

These silicides are simple, since they are binary silicides and not the more complex tertiary silicides.

The method according to the invention presents the advantage of resulting deposits (coatings, coverings) that are very refractory and able to resist high temperatures that under air can reach 1,600° C. or higher, because the temperature at which the coating is done is similarly 950 to 1,850° C. and the melting temperature of the compositions (solidus) varies generally from 900 to 1,820° C.

According to the invention, the coating compounds used must generally have a silicon content greater than or equal to 40 atom % in order not to be reactive with SiC.

In order for the coefficient of expansion of the coating compound to be close but greater than that of the silicon carbide, the percentage of silicon must preferably not exceed 97 atom %.

A method implementing the coating compounds whose atomic percentages are in the range mentioned above is simple to implement, because its compositions are non-reactive on the submicronic level and have very satisfactory wetting and adhering properties on the SiC. The coating compound itself is inexpensive, because it contains only low cost components.

Given the non-reactive character of the coating compound according to the invention, it is possible to dissolve the coating compound, if necessary, and to redo the coating operation. Since there is no reaction of the coating compound on the SiC, another subsequent coating operation, for instance for repair, is possible.

In addition to the implementation of a specific, non-reactive coating compound the second essential characteristic of the method according to the invention is the addition of a SiC and/or C reinforcement prior to heating the coating compound.

It should be noted from the start that the use of such reinforcement, which is more in conjunction with a coating compound, a fortiori a non-reactive coating compound, is neither disclosed nor suggested in the prior art.

The addition of a SiC and/or C reinforcement allows perfect adaptation of the coefficient of coating including the reinforcement plus the coating alloy in the SiC material. It is thuspossible, by virtue of the method according to the invention, to coat all known SiC materials.

Thus, the method according to the invention allows, for example, coating of SiC ceramics and SiC composites. The coating compounds used in the method according to the invention generally have an intrinsic coefficient of expansion that is not adapted to the SiC material and it is precisely the addition of a SiC and/or C reinforcement that allows adaptation of the global expansion of the coating to that of the SiC material to be coated.

The reinforcement, by precisely adapting the expansion, allows not only suppression of any possible cracking due to residual thermomechanical stress at the time of creating the coating but also obtaining a coating with enhanced and remarkably increased performance.

Expressed differently, on the one hand the non-reactive coating compounds used in the method according to the invention assure excellent chemical compatibility with the SiC material, wetting it satisfactorily and adhering well to it. On the other hand, in order to limit the residual stress that occurs at the time of cooling and as a result of the difference in coefficient of expansion between the SiC material and the coating compound, the global composition in the coating according to the invention includes a metal-silicon alloy and a SiC and/or C reinforcement, whose coefficient of expansion is close to that of the SiC material. This is all the more true the thicker the coating or the greater the mechanical load. Because the method according to the invention avoids any cracking induced either at the time of elaboration of the coating or at the time the coated part is put into service and which would be prejudicial to the service life of the part or component.

In other words, the very satisfactory adhesion of the deposit, the absence of reactivity and the mechanical compatibility of the composition with the ceramic does not compromise the deposit/SiC interface. Thus, once again, the coefficient of expansion of the composition approximates that of the SiC which, at the time of cooling, induces only very little residual stress and results in a covering, uniform deposit that is coherent with the ceramic. The purpose of said covering is, for example, the protection of the ceramic from corrosion and various oxidation such as that described above but it also permits, in the case of porous ceramics or composites, assurance of impermeability of the porous body relative to any liquid or gaseous environment. Depending on operating conditions, said coating is limited strictly to the surface of the SiC or penetrates into the inner porosities of the ceramic to a more or less significant depth as is demonstrated by observations using the electron microscope. As the coating modifies the surface of the ceramic, it can also contribute to enhancement of resistance to wear, to friction, to erosion, etc.

Further to the advantages already mentioned in the foregoing, it should be added that the coating compound used in the invention is a silicide whose elevated Si content reinforces its resistance to oxidation by the formation of a superficial layer of silicon.

The coating compound used according to the invention also has the advantage of being less sensitive to corrosion, for example by oleum, nitric acid and to oxidation.

Furthermore, due to the fact that the coating compound is non-reactive, the quality of the oven atmosphere is less critical; wetting or spreading is immediate even in atmospheres having not inconsiderable partial oxygen pressures such as, for example, using commercial grade argon and the coating operation can be realized not only under vacuum or under the simple protection of using a neutral gas, but also using reducing gases such as hydrogen.

The following can be mentioned as other advantages of the method of the invention:

short duration of the coating process by virtue of the absence of reaction, for example, of only 5 to 15 minutes. Moreover, the thermal inertia of the oven as a parameter of duration of the coating process is no longer critical and, if necessary, for example, in the case of coating large dimension parts the temperature maintenance time can be easily prolonged or adapted;

great simplicity inducing globally lower cost of the method; in fact, the coating process is simply done in one single pass by heating and melting the alloy composition onto the surface of the ceramic;

the wide range of compositions and reinforcements allows uncomplicated adaptation as a function of the desired properties such as protection against corrosion and/or oxidation of the material to be coated, impermeability, resistance to wear, etc.

The preferred coating compounds for utilization in the method according to the invention are:

50 to 97 atom % silicon, 50 to 3 atom % chrome (including the CrSi₂ composition), which for these compositions corresponds in mass quantities to: 34 to 94.5% by weight of silicon and 66 to 5.5% by weight of chrome. The coating temperature for these compositions is generally greater than 1,400° C. up to 1,550° C.

40 to 97 atom % silicon, 60 to 3 atom % rhenium, which for these compositions corresponds in mass quantities to: 9 to 82.5% by weight of silicon and 91 to 17.5% by weight of rhenium.

60 to 97 atom % silicon, 40 to 3 atom % titanium (including the TiSi₂ composition), which for these compositions corresponds in mass quantities to: 46 to 95% by weight of silicon and 54 to 5% by weight of titanium. The coating temperature for these compositions is generally greater than 1,400° C. up to 1,600° C.

55 to 97 atom % silicon, 45 to 3 atom % vanadium, which for these compositions corresponds in mass quantities to: 40 to 95% by weight of silicon and 60 to 5% by weight of vanadium.

60 to 97 atom % silicon, 40 to 3 atom % zirconium (including the ZrSi₂ composition), which for these compositions corresponds in mass quantities to: 31 to 95% by weight of silicon and 69 to 5% by weight of zirconium.

45 to 97 atom % silicon, 55 to 3 atom % ruthenium, which for these compositions corresponds in mass quantities to: 20 to 90% by weight of silicon and 80 to 10% by weight of ruthenium.

48 to 97 atom % silicon, 52 to 3 atom % iridium, which for these compositions corresponds in mass quantities to: 12 to 82.5% by weight of silicon and 88 to 17.5% by weight of iridium.

50 to 97 atom % silicon, 50 to 3 atom % rhodium, which for these compositions corresponds in mass quantities to: 21.5 to 90% by weight of silicon and 78.5 to 10% by weight of rhodium.

50 to 97 atom % silicon, 50 to 3 atom % palladium, which for these compositions corresponds in mass quantities to: 21 to 89.5% by weight of silicon and 21 to 10.5% by weight of palladium.

58 to 97 atom % cobalt, 42 to 3 atom % cobalt, which for these compositions corresponds in mass quantities to: 40 to 95% by weight of silicon and 60 to 5% by weight of cobalt.

50 to 97 atom % silicon, 50 to 3 atom % platinum, which for these compositions corresponds in mass quantities to: 12.5 to 82% by weight of silicon and 87.5 to 18% by weight of platinum.

53 to 97 atom % silicon, 47 to 3 atom % cerium, which for these compositions corresponds in mass quantities to: 18 to 90% by weight of silicon and 82 to 10% by weight of cerium.

Generally, the method according to the invention is realized by forming a powder of the coating compound, suspending said powder in an organic binder, applying the suspension obtained onto the surface of the part to be coated, adding a SiC and/or C reinforcement prior to heating in order to cause said coating compound to melt.

The coating compound can be applied to one surface of the part to be coated but preferably it is applied to the entire surface of said part.

As indicated in the foregoing, the purpose of the addition of SiC and/or C is namely to augment the toughness of the deposit and to adapt the coefficient of expansion of the coating compound to that of the SiC to be coated, generally by reducing the coefficient of expansion of the coating compound. Said addition of SiC and/or C is generally realized in quantities of from 3 to 60% by weight of SiC and/or C relative to the weight of the coating compound (that is the Si+metal assembly) described above.

It will be noted that the lower the proportion of Si in the coating compound, the greater the proportion of reinforcement required in order to compensate the increase of coefficient of expansion associated with the metal. Thus, in accordance with the coefficient of expansion of the different Si and metal alloys, it is necessary to have a greater or lesser proportion of reinforcement, generally with a minimum of 3% by weight.

Said addition of SiC and/or C reinforcement is done in several ways: by adding the SiC and/or C reinforcement to the coating compound prior to heating in order to melt the composition or by placing the reinforcement on the surface of the part to be coated.

The reinforcement may be in any appropriate form selected from: powders, granules, chips and particles of various shapes, fabric, non-fabric, felt, foam, etc.

Thus, more precisely:

some of the SiC and/or C powder can be added directly to the coating compound;

the SiC and/or C powder can be suspended in organic binder and the surface of the piece to be coated is covered with the suspension so obtained;

SiC and/or C particles can be added to the coating compound;

finally, the reinforcement and be applied in the form of a fabric, for example, a non-woven fabric, a felt or a foam of carbide or silicide and/or carbon on the surface of the part to be coated.

Said application is realized prior to the application of the coating compound onto the surface to be coated (Si+metal).

The addition of SiC and/or C (particles, fabric, etc.) allows coatings with increased toughness to be obtained as a result of the presence of particles of SiC and /or C or of a SiC and/or C fabric in the coating (covering).

In order to differentiate between particles and powder, it can be said that the granulometry of the latter is lower.

The invention relates also to a non-reactive refractory coating compound chosen from:

a coating compound comprised of, in atomic percentage, from 50 to 97% silicon and 50 to 3% chrome, the compound CrSi₂ being excluded;

a coating compound comprised of 40 to 97 atom % silicon, 60 to 3 atom % rhenium;.

a coating compound comprised of 60 to 97 atom % silicon, 40 to 3 atom % titanium, the compound TiSi₂ being excluded;

a coating compound comprised of 55 to 97 atom % silicon, 45 to 3 atom % vanadium;

a coating compound comprised of 60 to 97 atom % silicon, 40 to 3 atom % zirconium, the ZrSi₂ compound being excluded;

a coating compound comprised of 45 to 97 atom % silicon, 55 to 3 atom % ruthenium;

a coating compound comprised of 48 to 97 atom % silicon, 52 to 3 atom % iridium;

a coating compound comprised of 50 to 97 atom % silicon, 50 to 3 atom % rhodium;

a coating compound comprised of 50 to 97 atom % silicon, 50 to 3 atom % palladium;

a coating compound comprised of 58 to 97 atom % silicon, 42 to 3 atom % cobalt;

a coating compound comprised of 50 to 97 atom % silicon, 50 to 3 atom % platinum;

a coating compound comprised of 53 to 97 atom % silicon, 47 to 3 atom % cerium;

The invention also relates to a compound for non-reactive refractory coating of parts made of silicon carbide material comprising a non-reactive coating compound such as that defined in the foregoing and further an addition of a SiC and/or C reinforcement.

The invention relates further to the refractory coating, deposit or covering and the coated piece obtained by the method described above.

Other characteristics and advantages of the invention can be better understood by a reading of the following description, provided for illustration purposes but not limiting in character, together with reference to the attached drawings, wherein:

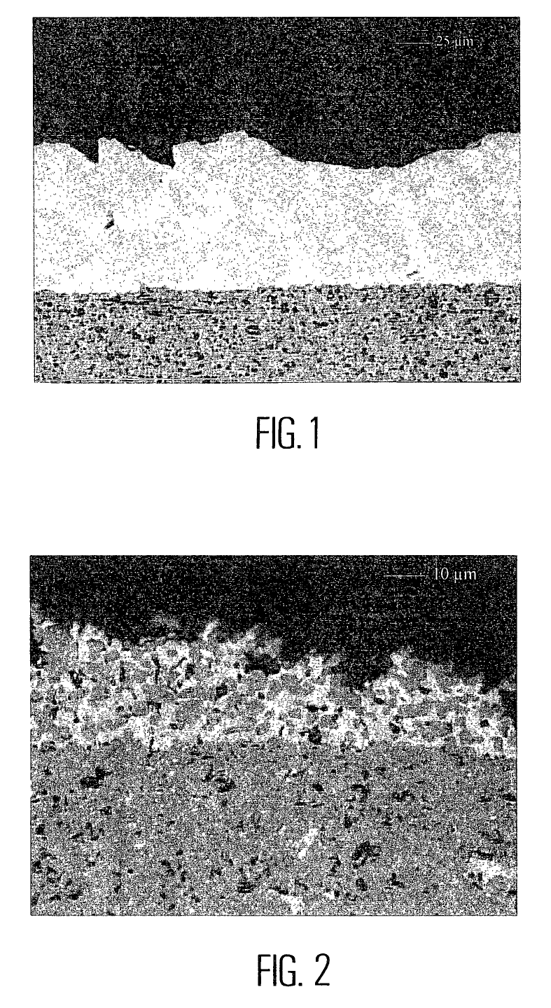

FIGS. 1 to 10 are micrographs of cross-sections showing several deposits or coatings made on SiC ceramics by the method of the invention.

These figures also show the deposit-ceramic interface and the infiltration of the ceramic by the coating thus assuring impermeability.

The method of the invention is comprised initially of the preparation of a coating compound containing silicon and chrome, rhenium, titanium, vanadium, zirconium, ruthenium, iridium, rhodium, palladium, cobalt, platinum or cerium in the desired proportions as indicated in the foregoing.

The coating compound is generally a powdered compound that can be prepared, for example, by synthesizing an intermetallic compound using pure ingredients and containing silicon and chrome, rhenium, titanium, vanadium, zirconium, ruthenium, iridium, rhodium, palladium, cobalt, platinum or cerium.

Synthesis of such an intermetallic compound is done, for example, by introducing the silicon, in the form of pieces for example, and the chrome, rhenium, titanium, vanadium, zirconium, ruthenium, iridium, rhodium, palladium, cobalt, platinum or cerium—in the form of filaments, pieces or the like—into an aluminum refractory crucible and heating, to a temperature of 1,250 to 1,850 for example, in order to melt the various constituents of said composition and obtaining the desired, homogeneous final intermetallic compound. The intermetallic compound obtained is then ground in any appropriate apparatus—in a mortar for example—to obtain a powder having the appropriate granulometry; that is, that the grains have a diameter of 1 to 250 μm for example.

Instead of being synthesized, said intermetallic compound can also be a commercial compound supplied in the form of a powder of the intermetallic compound having a known granulometry and a purity grade. Among the commercially available powders, the following can be names, for example: the powder of the compound CrSi₂, brand name CERAC® with a purity of 99.5% and a granulometry of less than 10 μm; the powder of the compound TiSi₂, brand name GOODFELLOW®, with a purity of 99.9% and a granulometry of less than 45 μm; the powder of the compound VSi₂, brand name CERAC® with a purity of 99.5% and a granulometry of less than 45 μm; the powder of the compound ZrSi₂, brand name CERAC®, with a purity of 99.9% and a granulometry of less than 45 μm; the powder of the compound CeSi₂, brand name CERAC®, with a purity of 99.5% and a granulometry or less than 10 μm and the powder of the compound Re₅Si₃, brand name GOODFELLOW® with a purity of 99.5 5 and a granulometry of less than 40 μm. This powder comprised of two intermetallic compounds can be used as a coating compound.

However, in order to adjust the Si content of the coating compound, it may be necessary to mix one of the powders of intermetallic compound mentioned above with pure silicon powder. Said pure silicon powder can be prepared using pieces of pure silicon ground in any appropriate apparatus, in a mortar for example, in order to obtain a powder having an appropriate granulometry; grains having a diameter of 1 to 250 μm for example.

Instead of being prepared in this fashion, said pure silicon powder can also be a commercial powder of known granulometry and purity. Among the commercial powders the following can be mentioned, for example: pure Si powder, brand name CERAC®, 99.5% or 99.9% pure and a granulometry of less than 10 μm.

The powder comprised of a mixture of the intermetallic compound and Si constituted in this case the coating compound.

In addition, according to the invention, the addition of a SiC and/or C reinforcement is made prior to heating of the coating compound in order to melt it. As already mentioned above, said addition of a SiC and/or C reinforcement can be made in different ways.

For, example, because the coating compound exhibits an elevated coefficient of expansion, SiC and/or C powder is added to it in order to diminish the coefficient of expansion and to adjust the toughness of the deposit and of the coated part. This is particularly the case when the Si content of the coating compound is not high enough that the coefficient of expansion of the deposit is adapted to that of the SiC of the part to be coated. The SiC and/or C added represents generally from 3 to 60% by weight of the coating compound. The SiC powder can be a commercial powder, like the STARCK® powder having 98.5% purity and a granulometry of less than 10 μm., for example.

The coating compound (Si and metal) eventually added from pure SiC and/or C powder is suspended in conventional fashion in a liquid organic binder, preferably relatively viscous, that decomposes, for example, between 100 and 300° C. without leaving traces. For example, it can be a NICROBRAZ® type cement.

The surface of the part made of SiC material that is to be coated is degreased in an organic solvent such as, for example cetone, ester, ether, alcohol or a mixture of these, etc., a preferred solvent being acetone or an ethyl ether alcohol-acetone mixture in the proportions ⅓, ⅓, ⅓; then dried. As used herein, the term “surface” may mean only a part of the total surface of the part but preferably it refers to the entire surface of the part.

The part made of SiC material that is to be coated can be one piece or a larger number of parts can be coated at the same time up to 100 pieces.

As examples of SiC materials pure dense silicon carbide or pressureless sintered silicon carbide (PLS-SiC or pressureless sintered SiC); siliconized silicon carbide (called SiSiC or RBSC containing 5 to 20% Sic); re-crystallized porous silicon (called RSiC) ; graphite silicon (C—SiC) comprised of graphite and coated with a layer of SiC 0.1 to 1 mm in thickness, for example; as well as the SiC/SiC composites, for example, with filaments or “whiskers;” the C/SiC compounds; for example, with carbon filaments or “whiskers” and SiC matrix; and the monocrystals of SiC; and the composites of SiC with another ceramic, for example the SiC/Si₃N₄ composites and SiC/TiN can be mentioned. It has been found that the method of the invention allows coating of SiC composites or sintered SiC with excellent results particularly in the field of protection against oxidation and corrosion. The method of the invention is also particularly advantageous when it is applied to high porosity, for example 0 to 50%, SiC materials (for example, composites), in which it allows assuring impermeability relative to any gaseous or liquid environment.

When used herein, the term silicon carbide material means generally any of the materials whose SiC content is greater than or equal to 80% by weight; however, certain materials to which the invention can apply and which are cited by way of example in the above can have a silicon carbide content of less than 80%.

In order to realize the addition of the SiC and/or C reinforcement, for example, the two surfaces of the parts made of SiC material can be covered using a pure SiC and/or pure C powder of the type described above suspended in an organic binder similar to those mentioned above; for example, using a solvent of the NICROBRAZ® type.

The surface of the part to be coated is then covered with a suspension of the coating suspension (Si and metal).

In another method of realizing the application, the addition of the SiC and/or C reinforcement is to add particles of SiC and/or C to the coating compound.

The addition of the reinforcement can also be done by applying said SiC and/or C reinforcement onto the surface of the part to be covered.

In this case, the reinforcement is preferably in the form of a SiC and/or C fabric, a non-woven fabric, a felt, or a foam.

By way of example of such fabrics, the HEXCEL® brand carbon fabrics can be mentioned. The thickness of such reinforcements, tissues for example, is generally 100 to 500 μm and their specific mass is generally 100 to 700 g/m². This thickness and specific mass are selected in such a fashion that the mass proportion is respected as indicated in the above between the coating compound (Si and metal) and the SiC and/or C reinforcement.

The part is now ready to be coated and is placed inside an oven, under vacuum or under neutral gas atmosphere.

Generally, the vacuum is a secondary vacuum; that is, the pressure is from 10⁻² to 10⁻⁵ Pa; for example, 10⁻⁴ Pa.

Preferably the neutral gas is argon.

The invention even permits using commercial grade argon having a not inconsiderable oxygen partial pressure.

From the start an initial temperature step is made that allows degassing of the entire assembly and evaporation of the organic binder called “debonding”; while a second temperature step allows the coating itself.

The first step is carried out, for example, at a temperature of 200 to 300° C., preferably 300° C. over a period of, for example, 0.5 to 1 hour.

The second step is carried out at a temperature corresponding to the melting temperature of the coating compound selected, but this temperature is preferably a temperature of at least 25° C. higher then the liquidus of the compound.

Depending on the compounds, this liquidus temperature varies from 900 to 1,820° C. The heating temperature (or the coating process temperature) will thus vary, for example, from 950° C. to 1,850° C., preferably from 1,200 to 1,850° C.

Coating is done simply by melting and spreading or flowing out of said coating compound over the surface of the part.

Such a melting temperature of the compounds allows, according to another advantage of the method of the invention, utilization of the coated piece up to 1,000° C. and even up to 1,600° C. under air.

The duration of the coating process; that is the thermal cycle of realization of the coating is, according to the invention, generally short: the time required for the step is less than 10 minutes, for example, preferably 5 to 10 minutes.

The covered part is then cooled to ambient temperature at a rate of 5° C. per minute, for example.

The coating or deposition obtained generally has a thickness of 1 to 50 μm on the surface of the part. The coating or covering is not only covering but occasionally penetrates into the open porosity of the part.

The parts coated in silicon carbide having a covering or a deposit prepared by the method according to the invention can be used directly as is but more generally they can be included in heavier sets and allow realization of structures, apparatus, components of complex forms having elevated utilization temperatures that can reach 1,600° C.

It is in fact known that the mechanical properties of silicon carbide, namely:

great hardness

low coefficient of expansion

increased resistance to breakage

good thermal shock resistance

as well as its good conductivity

make it an important material for present and future industrial high-temperature applications.

Furthermore, SiC exhibits very good chemical resistance to various acids, including fluorhydric acid and a very good resistance to oxidation under air at high temperatures up to 1,300° C.

All of these properties make SiC the material of choice particularly for the realization of ceramic heat exchangers for thermal engineering and chemical engineering. Thus, among the applications of the coated pieces obtained by the method according to the invention, the example can also be cited of thermal exchangers, burners, reactors, pump fittings, medium temperature atmospheric furnace resistors, but also automobile combustion chambers, the composites for the aeronautical industry as well as any of the structures intended for use in corrosive environments at temperatures up to 1,600° C.

The significant rigidity of SiC and its low density is likewise advantageous for application in the field of space.

The utilization of SiC ceramic products, in particular in the sintered or composite form, is thus very diverse. For reasons of manufacturing process, but also to lighten the ceramic, there is often recourse to products that are not dense and which can have quite high porosity. The problem of impermeability of these materials is advantageously resolved by the coating method according to the invention. Moreover and despite all of the remarkable qualities of SiC, utilization of covering deposits such as those prepared according to the invention is necessary to protect sintered SiC or SiC composite from any oxidizing environment or any corrosive environment (gas, liquid, acid, alkali, sufurated, fluorinated, and any high temperature, etc.). Most particularly, the sensitivity to oxidation of the C of the C/SiC being very high, utilization of the present method to cover parts made of these materials is particularly appropriate.

Finally, in some applications such as brake systems or mechanical parts for automobiles or aeronautics, coating according to the invention provides even more improvement of resistance to wear, erosion, abrasion, friction, etc. of the SiC parts.

The invention will now be described using the following illustrative but non-limiting examples.

The examples that follow are not exhaustive but are intended solely to illustrate the method of the invention by using diverse coating compounds with a reinforcement, different ceramics containing SiC and different thicknesses. Thus, the families of metals that share similar behaviors are Ru and Ir; Pd, Pt and Rh; Co, Ti and Cr; V and Zr; Re, and Ce.

The micrographs shown in the appended FIGS. 1 to 10 allow visualization of the deposit (coating) and the infiltration of same into the ceramic, thus assuring impermeability.

### EXAMPLE 1

This example relates to the coating of a part made of PLS α-SiC (PressureLess Sintered α-sic); that is, an unpressurized α sintered silicon carbide by the method of the invention and using a coating compound comprised of 90% by weight of Re and 10% by weight of Si with the addition of a reinforcement of SiC powder representing 3% by weight of the coating compound.

a) Preparation of the Coating Compound and the Part to be Coated

3% by weight of pure SiC powder is added to a commercial powder having the composition of 90% by weight Re and 10% by weight Si, brand name GOODFELLOW®, with a purity of 99.9% and a granulometry of less than 20 μm.

The surface of the SiC to be covered is degreased in an organic solvent, then dried. The assembly formed by the alloy compound and the SiC powder is mixed in an organic binder that is a NICROBRAZ® type cement and applied to the entire surface of the SiC to be coated.

b) Coating

The prepped SiC part is placed in the oven. A first step at 300° C. for 1 hour for the purpose of eliminating the organic binder then the actual coating is done under the following conditions:

Temperature: 1,800° C.

Duration of the Step: 10 minutes

Atmosphere: Argon at atmospheric pressure.

The coated part obtained is then cooled to ambient temperature at the rate of 5° C. per minute.

c) Observation of the Deposit

On removal from the oven, the melted compound forms a thick, dense, covering deposit on the ceramic. A micrograph taken of a cross-section shows the deposit protecting the ceramic (cf. FIG. 1).

### EXAMPLE 2

This example relates to the coating of a part made of PLS α-SiC (PressureLess Sintered α-SiC); that is, an unpressurized α sintered silicon carbide by the method of the invention and using a coating compound comprised of VSi₂ with the addition of a reinforcement of SiC powder representing 50% by weight of the coating compound.

a) Preparation of the Coating Compound and the Part to be Coated

50% by weight of pure SiC powder is added to a commercial powder having the composition of VSi₂, brand name GOODFELLOW®, with a purity of 99.9% and a granulometry of less than 45 μm.

The surface of the SiC to be covered is degreased in an organic solvent, then dried. The assembly formed by the VSi₂ and the SiC powder is mixed in an organic binder that is a NICROBRAZ® type cement and applied to the entire surface of the SiC to be coated.

b) Coating

The prepped SiC part is placed in the oven under secondary vacuum. A first step at 300° C. for 1 hour for the purpose of eliminating the organic binder then the actual coating is done under the following conditions:

Temperature: 1,700° C.

Duration of the Step: 5 minutes

Atmosphere: Argon at atmospheric pressure.

d) Observation of the Deposit

On removal from the oven, the melted compound forms a thick, dense, covering deposit on the ceramic. A micrograph taken of a cross-section shows the deposit comprised of VSi₂ and SiC protecting the ceramic and the infiltration of the ceramic assuring impermeability (cf. FIG. 2).

### EXAMPLE 3

This example relates to the coating of a part made of PLS α-SiC (PressureLess Sintered α-SiC); that is, an unpressurized α sintered silicon carbide by the method of the invention and using a coating compound comprised of 29% by weight of chrome and 71% by weight of Si with the addition of a reinforcement of SiC powder representing 5% by weight of the coating compound.

a) Preparation of the Coating Compound and the Part to be Coated

A commercial powder of CrSi₂ compound, brand name CERAC®, with a purity of 99.5% and a granulometry of less than 10 μm is mixed with a pure Si powder, brand name CERAC®, with a purity of 99.5% and a granulometry of less than 10 μm in the following mass proportions: 60.4% by weight of CrSi₂ and 39.6% by weight of Si. This mixture corresponds to a global composition of 29% by weight of Cr and 71% by weight of Si. 5% by weight of SiC is added to this composition.

The surface of the SiC to be covered is degreased in an organic solvent, then dried. The assembly formed by the alloy compound and the SiC powder is mixed in an organic binder that is a NICROBRAZ® type cement and applied to evenly the surface of the SiC to be coated.

b) Coating

The prepped SiC part is placed in the oven. A first step at 300° C. for 1 hour for the purpose of eliminating the organic binder then the actual coating is done under the following conditions:

Temperature: 1,360° C.

Duration of the Step: 5 minutes

Atmosphere: 10⁻⁵ mbar.

The coated part obtained is then cooled to ambient temperature at the rate of 5° C. per minute.

c) Observation of the Deposit

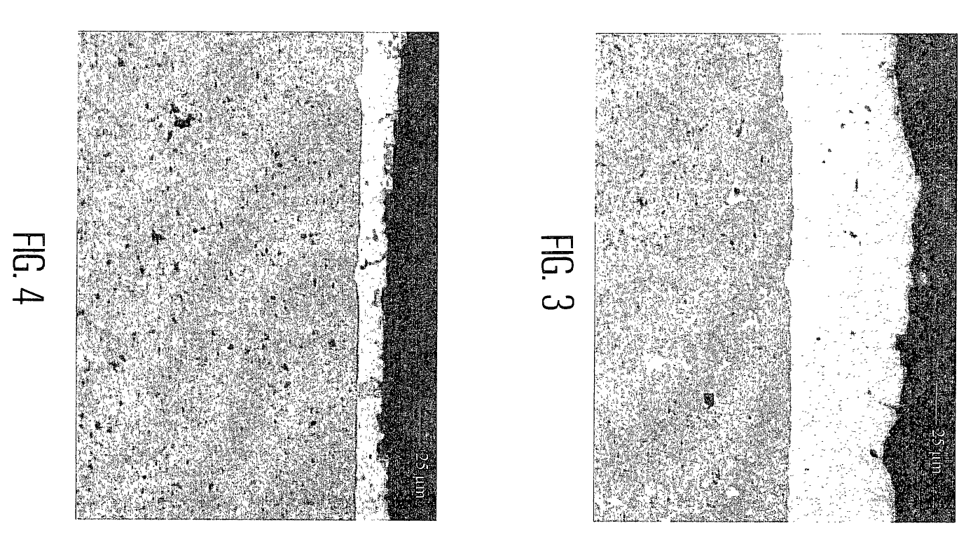

On removal from the oven, the melted compound forms a thick, dense, covering deposit on the ceramic. A micrograph taken of a cross-section shows the deposit protecting the ceramic and the infiltration of the ceramic assuring impermeability (cf. FIG. 3).

### EXAMPLE 4

This example relates to the coating of a part made of PLS α-SiC (PressureLess Sintered α-SiC) ; that is, an unpressurized α sintered silicon carbide by the method of the invention and using a coating compound comprised of 25% by weight of titanium and 75% by weight of silicon with the addition of a reinforcement of SiC powder representing 5% by weight of the coating compound.

a) Preparation of the Coating Compound and the Part to be Coated

A commercial powder of TiSi₂ compound, brand name GOODFELLOW®, with a purity of 99.9% and a granulometry of less than 45 μm is mixed with a pure Si powder, brand name CERAC®, with a purity of 99.99% and a granulometry of less than 10 μm in the following mass proportions: 54.3% by weight of TiSi₂ and 45.6% by weight of Si. This mixture corresponds to a global composition of 25% by weight of Ti and 75% by weight of Si. 5% by weight of SiC is added to this composition.

The surface of the SiC to be covered is degreased in an organic solvent, then dried. The assembly formed by the alloy compound and the SiC powder is mixed in an organic binder that is a NICROBRAZ® type cement and applied to the entire surface of the SiC to be coated.

b) Coating

The prepped SiC part is placed in the oven under secondary vacuum. A first step at 300° C. for 1 hour for the purpose of eliminating the organic binder then the actual coating is done under the following conditions:

Temperature: 1,360° C.

Duration of the Step: 5 minutes

Atmosphere: 10⁻⁵ mbar.

The coated part obtained is then cooled to ambient temperature at the rate of 5° C. per minute.

c) Observation of the Deposit

On removal from the oven, the melted compound forms a thick, dense, covering deposit on the ceramic. A micrograph taken of a cross-section shows the deposit protecting the ceramic and the infiltration of the ceramic assuring impermeability (cf. FIG. 4).

### EXAMPLE 5

This example relates to the coating of a part made of PLS α-SiC (PressureLess Sintered α-SiC); that is, an unpressurized α sintered silicon carbide by the method of the invention and using a coating compound comprised of 50% by weight of TiSi₂ with the addition of a reinforcement of SiC powder representing 50% by weight of the coating compound.

a) Preparation of the Coating Compound and the Part to be Coated

A commercial powder of TiSi₂ compound, brand name GOODFELLOW®, with a purity of 99.9% and a granulometry of less than 45 μm is mixed with a SiC in the following mass proportions: 54% by weight of TiSi₂ and 50% by weight of SiC.

The surface of the SiC to be covered is degreased in an organic solvent, then dried. The assembly formed by the alloy compound and the SiC powder is mixed in an organic binder that is a NICROBRAZ® type cement and applied to the entire surface of the SiC to be coated.

b) Coating

The prepped SiC part is placed in the oven under secondary vacuum. A first step at 300° C. for 1 hour for the purpose of eliminating the organic binder then the actual coating is done under the following conditions:

Temperature: 1,530° C.

Duration of the Step: 5 minutes

Atmosphere: Argon at atmospheric pressure.

The coated part obtained is then cooled to ambient temperature at the rate of 5° C. per minute.

c) Observation of the Deposit

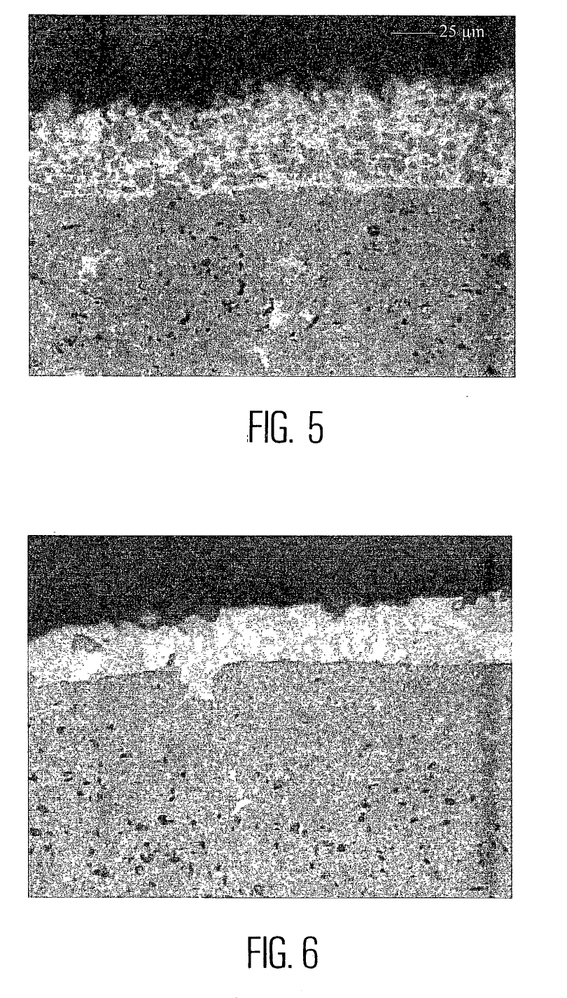

On removal from the oven, the melted compound forms a thick, dense, covering deposit on the ceramic. A micrograph taken of a cross-section shows the deposit comprised of SiC and TiSi₂ protecting the ceramic and the infiltration of the ceramic assuring impermeability (cf. FIG. 5).

### EXAMPLE 6

This example relates to the coating of a part made of PLS α-SiC (PressureLess Sintered α-SiC); that is, an unpressurized α sintered silicon carbide by the method of the invention and using a coating compound comprised of 43% by weight of cerium and 57% by weight of silicon with the addition of a reinforcement of SiC powder representing 5% by weight of the coating compound.

a) Preparation of the Coating Compound and the Part to be Coated

A commercial powder of CeSi₂ compound, brand name CERAC®, with a purity of 99.5% and a granulometry of less than 10 μm is mixed with a pure Si powder, brand name CERAC®, with a purity of 99.5% and a granulometry of less than 10 μm in the following mass proportions: 59.3% by weight of CeSi₂ and 40.7% by weight of Si. This mixture corresponds to a global composition of 43% by weight of Ce and 57% by weight of Si. 5% by weight of SiC is added to this composition. 3% by weight of SiC powder is added to this composition.

The surface of the SiC to be covered is degreased in an organic solvent, then dried. The assembly formed by the alloy compound and the SiC powder is mixed in an organic binder that is a NICROBRAZ® type cement and applied to the entire surface of the SiC to be coated.

b) Coating

The prepped SiC part is placed in the oven. A first step at 300° C. for 1 hour for the purpose of eliminating the organic binder then the actual coating is done under the following conditions:

Temperature: 1,300° C.

Duration of the Step: 5 minutes

Atmosphere: 10⁻⁴ mbar.

The coated part obtained is then cooled to ambient temperature at the rate of 5° C. per minute.

c) Observation of the Deposit

On removal from the oven, the melted compound forms a thick, dense, covering deposit on the ceramic. A micrograph taken of a cross-section shows the deposit protecting the ceramic and the infiltration of the ceramic assuring impermeability (cf. FIG. 6).

### EXAMPLE 7

This example relates to the coating of a part made of PLS α-SiC (PressureLess Sintered α-SiC); that is, an unpressurized α sintered silicon carbide by the method of the invention and using a coating compound comprised of 63% by weight of rhodium and 37% by weight of silicon with the addition of a reinforcement of SiC powder representing 3% by weight of the coating compound.

a) Preparation of the Coating Compound and the Part to be Coated

3% by weight of SiC powder is added to a commercial powder having the composition of 63% by weight Rh—37% by weight Si, brand name GOODFELLOW®, with a purity of 99.9% and a granulometry of less than 20 μm.

The surface of the SiC to be covered is degreased in an organic solvent, then dried. The assembly formed by the alloy compound and the SiC powder is mixed in an organic binder that is a NICROBRAZ® type cement and applied to the entire surface of the SiC to be coated.

b) Coating

The prepped SiC part is placed in the oven. A first step at 300° C. for 1 hour for the purpose of eliminating the organic binder then the actual coating is done under the following conditions:

Temperature: 1,200° C.

Duration of the Step: 5 minutes

Atmosphere: 10⁻⁴ mbar.

The coated part obtained is then cooled to ambient temperature at the rate of 5° C. per minute.

c) Observation of the Deposit

On removal from the oven, the melted compound forms a thick, dense, covering deposit on the ceramic. A micrograph taken of a cross-section shows the deposit protecting the ceramic and the infiltration of the ceramic assuring impermeability (cf. FIG. 7).

### EXAMPLE 8

This example relates to the coating of a part made of PLS α-SiC (PressureLess Sintered α-SiC); that is, an unpressurized α sintered silicon carbide by the method of the invention and using a coating compound comprised of 26.5% by weight of zirconium and 73.5% by weight of silicon with the addition of a reinforcement of SiC powder representing 3% by weight of the coating compound.

a) Preparation of the Coating Compound and the Part to be Coated

A commercial powder of ZrSi₂ compound, brand name CERAC®, with a purity of 99.5% and a granulometry of less than 45 μm is mixed with a pure Si powder, brand name CERAC®, with a purity of 99.5% and a granulometry of less than 10 μm in the following mass proportions: 43% by weight of ZrSi₂ and 57% by weight of Si. This mixture corresponds to a global composition of 26.5% by weight of Zr and 73.5% by weight of Si. 3% by weight of SiC powder is added to this composition.

The surface of the SiC to be covered is degreased in an organic solvent, then dried. The assembly formed by the alloy compound and the SiC powder is mixed in an organic binder that is a NICROBRAZ® type cement and applied to the entire surface of the SiC to be coated.

b) Coating

The SiC part ready for coating is placed in the oven. A first step at 300° C. for 1 hour for the purpose of eliminating the organic binder then the actual brazing is done under the following conditions:

Temperature: 1,400° C.

Duration of the Step: 5 minutes

Atmosphere: 10⁻⁵ mbar.

The coated part obtained is then cooled to ambient temperature at the rate of 5° C. per minute.

c) Observation of the Deposit

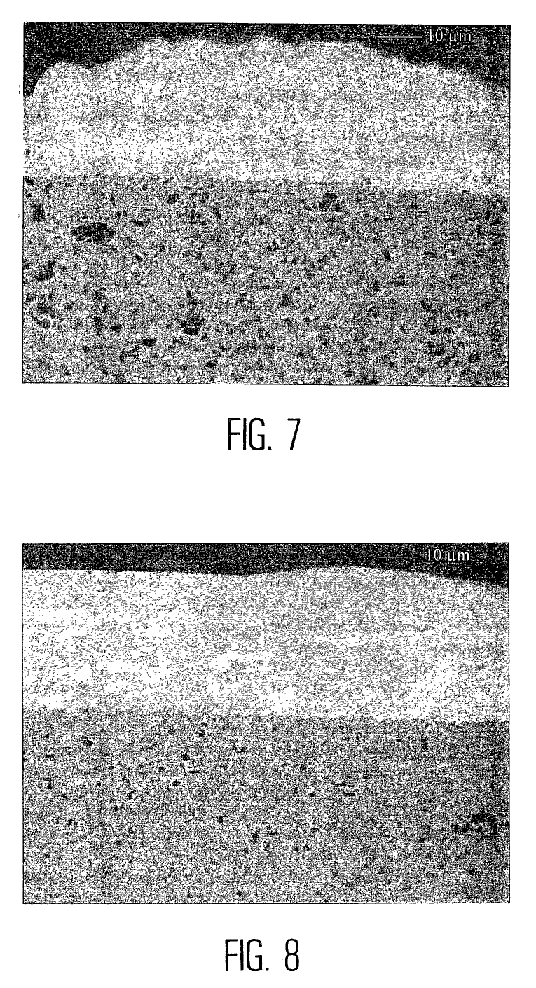

On removal from the oven, the melted compound forms a thick, dense, covering deposit on the ceramic. A micrograph taken of a cross-section shows the deposit protecting the ceramic and the infiltration of the ceramic assuring impermeability (cf. FIG. 8).

### EXAMPLE 9

This example relates to the coating of a C/SiC composite part by the method of the invention and using a coating compound comprised of 26.5% by weight of zirconium and 73.5% by weight of Si with the addition of a reinforcement of SiC powder representing 3% by weight of the coating compound.

a) Preparation of the Coating Compound and the Part to be Coated

A commercial powder of ZrSi₂ compound, brand name CERAC®, with a purity of 99.5% and a granulometry of less than 45 μm is mixed with a pure Si powder, brand name CERAC®, with a purity of 99.5% and a granulometry of less than 10 μm in the following mass proportions: 43% by weight of ZrSi₂ and 57% by weight of Si. This mixture corresponds to a global composition of 26.5% by weight of Zr and 73.5% by weight of Si. 3% by weight of SiC powder is added to this composition.

The surface of the SiC to be covered is degreased in an organic solvent, then dried. The assembly formed by the alloy compound and the SiC powder is mixed in an organic binder that is a NICROBRAZ® type cement and applied to the entire surface of the SiC to be coated.

b) Coating

The C/SiC composite part prepped for coating is placed in the oven. A first step at 300° C. for 1 hour for the purpose of eliminating the organic binder then the actual coating is done under the following conditions:

Temperature: 1,400° C.

Duration of the Step: 5 minutes

Atmosphere: 10⁻⁵ mbar.

The coated part obtained is then cooled to ambient temperature at the rate of 5°0 C. per minute.

c) Observation of the Deposit

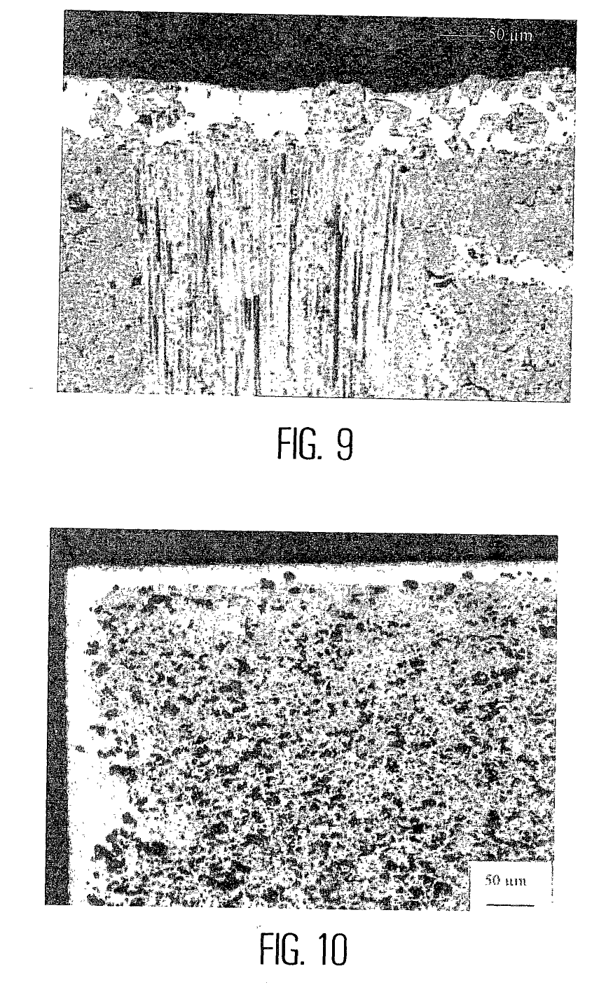

On removal from the oven, the melted compound forms a thick, dense, covering deposit on the ceramic. A micrograph taken of a cross-section shows the deposit protecting the ceramic and the infiltration of the ceramic assuring impermeability (cf. FIG. 9).

### EXAMPLE 10

This example relates to the coating of a highly porous sintered SiC part by the method of the invention and using a coating compound comprised of 26.5% by weight of zirconium and 72.5% by weight of silicon with the addition of a reinforcement of SiC powder representing 3% by weight of the coating compound.

a) Preparation of the Coating Compound and the Part to be Coated

A commercial powder of ZrSi₂ compound, brand name CERAC®, with a purity of 99.5% and a granulometry of less than 45 μm is mixed with a pure Si powder, brand name CERAC®, with a purity of 99.5% and a granulometry of less than 10 μm in the following mass proportions: 43% by weight of ZrSi₂ and 57% by weight of Si. This mixture corresponds to a global composition of 26.5% by weight of Zr and 73.5% by weight of Si. 3% by weight of SiC powder is added to this composition. The porous SiC part to be covered is wetted in an organic solvent and then dried.

We note that the porosity of this ceramic is very high; that is, around 40%.

The assembly formed by the alloy compound and the SiC powder is mixed in an organic binder that is a NICROBRAZ® type cement and applied to the entire surface of the SiC to be coated.

b) Coating

The SiC part ready for coating is placed in the oven. A first step at 300° C. for 1 hour for the purpose of eliminating the organic binder then the actual brazing is done under the following conditions:

Temperature: 1,400° C.

Duration of the Step: 5 minutes

Atmosphere: 10⁻⁵ mbar.

The coated part obtained is then cooled to ambient temperature at the rate of 5° C. per minute.

c) Observation of the Deposit

On removal from the oven, the melted compound forms a thick, dense, covering deposit on the ceramic. A micrograph taken of a cross-section shows the deposit protecting the ceramic and the infiltration of the highly porous ceramic assuring impermeability (cf. FIG. 10).

1. A method for coating of a part made of silicon carbide material, wherein a coating compound is applied to at least one surface of said part and the assembly formed by the part and the coating compound is heated to a temperature sufficient to cause the surface of the coating compound to melt in order to coat said piece with a deposit of silicon carbide material, wherein the coating compound is a non-reactive composition comprised, in atomic percentages, of 40 to 97% silicon and 60 to 3% of another element selected from chrome, rhenium, titanium, vanadium, ruthenium, iridium, rhodium, palladium, cobalt, platinum, cerium and zirconium and, wherein prior to heating, a reinforcement of SiC and/or C is added.

2. A method according to claim 1, wherein the coating is made at a temperature of between 950 and 1,850° C.

3. A method according to claim 2, wherein said coating compound is comprised, in atomic percentages, of 50 to 97% silicon and 50 to 3% chrome.

4. A method according to claim 2, wherein said coating compound is comprised, in atomic percentages, of 40 to 97% silicon and 60 to 3% rhenium.

5. A method according to claim 2, wherein said coating compound is comprised, in atomic percentages, of 60 to 97% silicon and 40 to 3% titanium.

6. A method according to claim 2, wherein said coating compound is comprised, in atomic percentages, of 55 to 97% silicon and 45 to 3% vanadium.

7. A method according to claim 2, wherein said coating compound is comprised, in atomic percentages, of 60 to 97% silicon and 40 to 3% zirconium.

8. A method according to claim 2, wherein said coating compound is comprised, in atomic percentages, of 45 to 97% silicon and 55 to 3% ruthenium.

9. A method according to claim 2, wherein said coating compound is comprised, in atomic percentages, of 48 to 97% silicon and 52 to 3% iridium.

10. A method according to claim 2, wherein said coating compound is comprised, in atomic percentages, of 50 to 97% silicon and 50 to 3% rhodium.

11. A method according to claim 2, wherein said coating compound is comprised, in atomic percentages, of 50 to 97% silicon and 50 to 3% palladium.

12. A method according to claim 2, wherein said coating compound is comprised, in atomic percentages, of 58 to 97% silicon and 42 to 3% cobalt.

13. A method according to claim 2, wherein said coating compound is comprised, in atomic percentages, of 50 to 97% silicon and 50 to 3% platinum.

14. A method according to claim 2, wherein said coating compound is comprised, in atomic percentages, of 53 to 97% silicon and 47 to 3% cerium.

15. A method according to one of claims 1 to 14, wherein a powder is formed of the coating compound and said powder is placed in suspension in an organic binder, the suspension so obtained is applied to the surface of the part to be coated, and a reinforcement of SiC and/or C is added prior to heating.

16. A method according to one of claims 1 to 15, wherein said addition of a SiC and/or C reinforcement is done in a quantity of 3 to 60% by weight of SiC and/or C with relative to the weight of the coating compound.

17. A method according to one of claims 1 to 16, wherein said addition of a SiC and/or C reinforcement is done by adding said SiC and/or C reinforcement to the coating compound prior to heating or by placing the reinforcement on the surface of the part to be coated.

18. A method according to one of claims 1 to 17, wherein said SiC and/or C reinforcement is in the form chosen from a powder, a granulate, pieces, particles, a woven fabric, a non-woven fabric, a felt and a foam.

19. A method according to one of claims 16 to 18, wherein said addition of SiC and/or C is done by mixing the SiC and/or C powder directly with the coating compound.

20. A method according to one of claims 16 to 18, wherein said addition of SiC and/or C reinforcement is done by placing the SiC and/or C powder in suspension in an organic binder and covering the surface of the part to be coated with the suspension so obtained.

21. A method according to one of claims 16 to 18, wherein said addition of SiC and/or C reinforcement is done by adding particles of SiC and/or C to the coating compound.

22. A method according to one of claims 16 to 18, wherein said addition of a SiC and/or C reinforcement is done by application of a fabric, an non-woven fabric, felt or a foam of silicon carbide and/or carbon onto the surface of the part to be coated.

23. A method according to one of claims 1 to 22, wherein the silicon carbide materials are chosen from among pressureless sintered silicon carbide (“PLS-SiC”); siliconized silicon carbide (“SiSiC” or “RBSC”) ; porous re-crystallized silicon carbide (“RSiC”); graphite silicon (“C—SiC”) comprised of graphite and coated with a layer of SiC; the SiC/SiC composites, with filaments or “whiskers” for example; the C/SiC composites, with carbon filaments or “whiskers” with a SiC matrix, for example; the monocrystalline SiC; the composites of SiC with another ceramic such as the SiC/Si₃N₄ and SiC/TiN composites, for example.

24. A Method according to one of claims 1 to 23, wherein said silicon carbide materials have a silicon carbide content of greater than or equal to 80% by weight.

25. A process according to one of claims 1 to 24, wherein said silicon carbide material has a porosity of 0 to 50%.

26. A non-reactive, refractory composition chosen from:
a coating compound comprised, in atomic percentages, of 50 to 97% silicon and 50 to 3% chrome, the compound CrSi₂ being excluded;
a coating compound comprised, in atomic percentages, of 40 to 97% silicon and 60 to 3% rhenium;
a coating compound comprised, in atomic percentages, of 60 to 97% silicon and 40 to 3 titanium, the compound TiSi₂ being excluded;
a coating compound comprised, in atomic percentages, of 55 to 97% silicon and 45 to 3% vanadium;
a coating compound comprised, in atomic percentages, of 60 to 97% silicon and 40 to 3% zirconium, the compound ZrSi₂ being excluded;
a coating compound comprised, in atomic percentages, of 45 to 97% silicon and 55 to 3% ruthenium;
a coating compound comprised, in atomic percentages, of 48 to 97% silicon and 52 to 3% iridium;
a coating compound comprised, in atomic percentages, of 50 to 97% silicon and 50 to 3% rhodium;
a coating compound comprised, in atomic percentages, of 50 to 97% silicon and 50 to 3% palladium;
a coating compound comprised, in atomic percentages, of 58 to 97% silicon and 42 to 3% cobalt;
a coating compound comprised, in atomic percentages, of 50 to 97% silicon and 50 to 3% platinum;
a coating compound comprised, in atomic percentages, of 53 to 97% silicon and 47 to 3% cerium;

27. A compound for non-reactive, refractory coating of parts made of silicon carbide material comprising a non-reactive coating compound according to claim 26 and, further, the addition of a reinforcement of SiC and/or C.

28. A refractory coating, deposit or covering capable of being obtained by the method of one of claims 1 to 25.
